(19) United States
(12) Patent Application Publication
(10) Pub. No.: US 2018/0300748 A1
(43) Pub. Date: Oct. 18, 2018

(54) TECHNOLOGIES FOR GRANULAR ATTRIBUTION OF VALUE TO CONVERSION EVENTS IN MULTISTAGE CONVERSION PROCESSES

(71) Applicant: Vladyslav Flaks, Dnipro (UA)

(72) Inventor: Vladyslav Flaks, Dnipro (UA)

(21) Appl. No.: 15/902,085

(22) Filed: Feb. 22, 2018

Related U.S. Application Data
(60) Provisional application No. 62/485,692, filed on Apr. 14, 2017.

(51) Int. Cl. G06Q 30/02; G06F 17/30

(52) U.S. Cl. CPC G06Q 30/0243; G06Q 30/0246; G06F 17/30598

(57) ABSTRACT

Technologies for attributing a value of a purchased product to individual stages of a multistage conversion path include an attribution server and an online touchpoint. Information regarding products for purchase is presented by an online touchpoint. Users interact with the online touchpoint in connection with the purchase of a product presented by the online touchpoint. The attribution server collects data indicative of user interaction with the touchpoint in connection with the purchase of the product. The attribution server may also collect data indicative of external influences that stimulated the user to interact with the online touchpoint. The interactions of the user via the touchpoint are grouped and a score for each stage of the multi-stage conversion path is calculated. A value for each user interaction that moved the user forward through the multi-stage conversion path is determined based on the calculated scores. Other embodiments are described and claimed.

### CROSS REFERENCE TO RELATED APPLICATION

This application claims the benefit of U.S. Provisional Patent Application No. 62/485,692, filed on Apr. 14, 2017, the disclosure of which is hereby incorporated herein by reference in its entirety.

### FIELD OF THE INVENTION

Embodiments of the technologies described herein relate, in general, to analyzing online and offline user interactions to provide attribution models. More particularly, the technologies described herein relate to systems and methods for uniquely identifying user devices and building connections between users' actions to provide attribution models that improve cost efficiency, advertising, and marketing of a business.

### BACKGROUND

Analysis of user actions on touchpoints has always been crucial for retail business owners, especially for omnichannel retailers. Nowadays, it is hard to obtain and analyze data from different sources that reflects and connects a user's behavior (or actions) on the touchpoint via different devices and offline interactions (through the purchases in stores, communication with managers or call center consultation) with the particular sources that influenced the user to implement these actions. It is also difficult to assign value to the sources that followed the user on their way to conversion.

Legacy approaches designed to provide analysis of user actions have various imperfections. One such approach is the Last-Click Attribution model, which was one of the first attribution models developed in online advertising in order to allow owners of businesses selling their products and services online to determine the type of returning and number of returning customers thereby changing their product and service lines. Last-Click Attribution model refers to a web analytics model in which the “last click” is given credit for a sale or conversion. In other words, if someone comes to business's website and orders certain product, business owner should have a web analytics system in place that tells the business owner where that customer came from. But the great flaw in web analytics packages is that many visitors come to the website of the business multiple times before converting, and the business owners need to choose whether they want the credit for a sale to go to the “first click” that introduced the customers to the website of the business, or to the “last click” that helped to convert the customer. Today, most web analytics packages are defaulted to “last click” analysis. However, what the business owners really need to know is the impact of each influence on users' behavior that converted visitors into customers.

Alluding to the above, several attribution models were developed. One of them is Single Source Attribution model, which assigns all the credit to one event, such as the last click, the first click or the last channel to show an advertising (post view). Simple or last-click attribution is widely considered as less accurate than alternative forms of attribution as it fails to account for all contributing factors that led to a desired outcome.

Another attribution model is called Fractional Attribution, which includes equal weights, customer credit, and multi-touch/curve models. Equal weight models give the same amount of credit to the events, customer credit uses past experience and sometimes simply guesswork to allocate credit, and the multi-touch assigns various credit to across all the touchpoints in the buyer journey at set amounts.

Still another approach is a model known as the Algorithmic or Probabilistic Attribution model. The Algorithmic or Probabilistic Attribution model uses science, usually proprietary algorithms, to assign conversion credit across all touch points preceding the conversion, using automated computation to decide where credit is due. Algorithmic attribution starts at the event level and analyzes both converting and non-converting paths across all channels. Weights are then grouped by placement, site, or channel as reporting granularity is decreased, allowing the data to point out the hidden correlations and insights within marketing efforts.

Internet advertising campaigns vary in price, depending on several factors such as where the advertising is to be placed and the expected viewing population. A problem for retail businesses having touchpoints is analyzing which category of product (or brands) has high efficiency in the retail space.

The technologies disclosed herein are designed to help connect and evaluate the applied efforts for the promotion of an item, a group of items, and/or brand and the results of such efforts (e.g. sale of products) based on influences contributing to a user's passage through different conversion path stages via a touchpoint.

It should be appreciated that combining and utilizing data from different mediums (i.e., online and offline) advantageously enables value to be attributed to any kind of entity and to any kind of influence.

The technologies disclosed herein also provide an improved attribution model, which as the result of attribution process, the value of conversion will be attributed to the user interaction instead of the advertising campaign and activities. Such improved attribution model can be utilized by the system to calculate and analyze not only the last step of the conversion stages (i.e., conversion), but each action of a visitor of the touchpoint that moved the visitor forward through the conversion path stages. The disclosed technologies also segment visitors and consider significant behavioral differences within each segment to weight each user/visitor action.

Accordingly, the technologies disclosed herein fulfill remaining need to analyze the effectiveness of different influences (e.g. email letter, advertising campaigns or friend's recommendation) to determine their relative worth in promotion of items, a group of items, and/or brands by providing ability to make reports and visualizations using natural language.

### SUMMARY OF THE INVENTION

These technologies disclosed herein include a system and a method that offer an attribution model for user interactions that occur through online or offline touchpoints at which items (e.g., products, services, etc.) are presented. In some embodiments, the system 400 includes information and/or data associated with one or more users that interacted and/or connected with the touchpoints(s) via one or more computing devices (e.g., computers, laptops, smartphones, tablet computers, portable electronic devices, etc.).

Additionally, in some embodiments, the system 400 also includes data and/or information associated with various influences (e.g., advertising sites, product placements, blogger recommendations etc.), touchpoint data, and third party data, which may be gathered by the attribution server 402. In operation, the attribution server analyzes user interactions with the items based at least in part on, or otherwise as a function of, value(s) assigned to user actions that lead to the user moving forward through one or more conversion path stages. After the analysis is completed, the attribution server 402 connects each action of the user/visitor of the touchpoint and/or each item selected/viewed by the user/visitor of the touchpoint with the specific influence. Thereafter, the attribution server 402 assigns a value and a score to each action and influence. In some embodiments, the attribution server 402 may assign the value and/or score to separate segments, as desired by the user/operator of the attribution server 402.

The foregoing and other objects, features, and advantages of the technologies disclosed herein will become more readily apparent from the following detailed description of a preferred embodiment that proceeds with reference to the drawings.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a simplified block diagram of at least one embodiment of a system for granularly attributing purchase events in a multistage conversion process;

FIG. 2 is a simplified flow diagram of at least one embodiment of a method that may be executed by the attribution server of FIG. 1 for determining occurrence probabilities of conversion path stages;

FIG. 3 is a simplified flow diagram of at least one embodiment of a method that may be executed by the attribution server of FIG. 1 for scoring and determining values for conversion path stages;

FIG. 4A depicts one example of user interaction data that may be generated by the attribution server of FIG. 1; and

FIG. 4B depicts various example data analysis processing operations that may be performed by the attribution server of FIG. 1 using the user interaction data of FIG. 4A.

### DETAILED DESCRIPTION

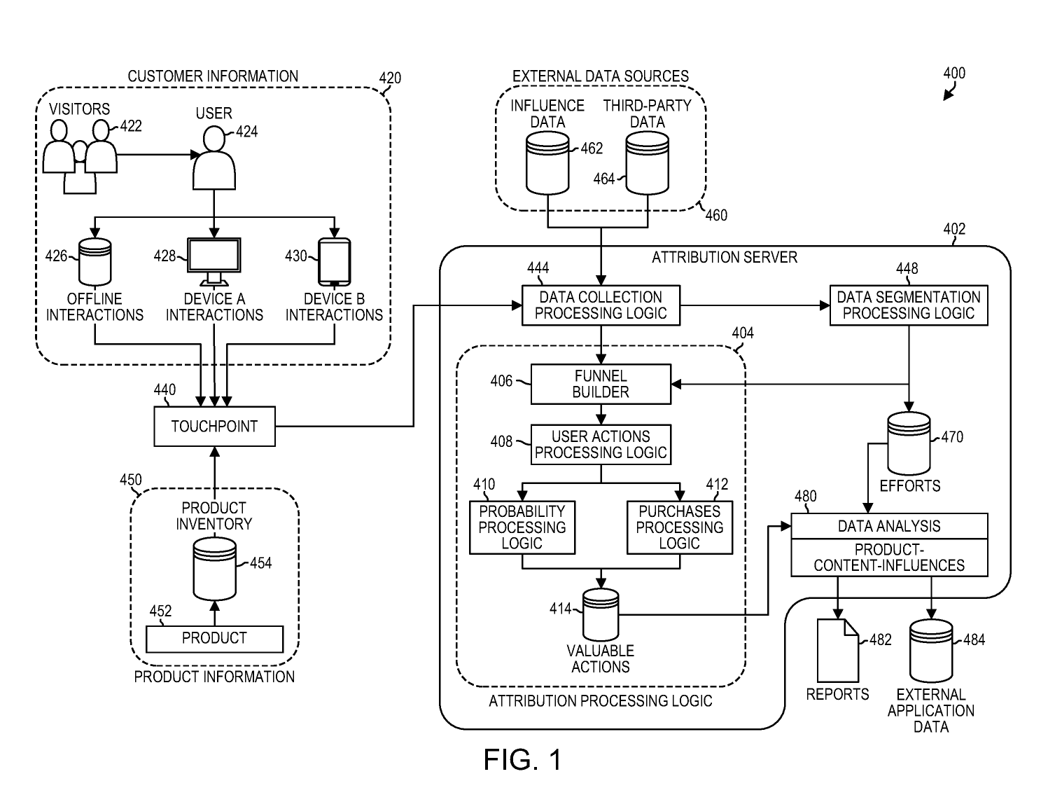

Referring now to FIG. 1, a system 400 is illustratively shown for granularly attributing purchase events in a multistage conversion process. Such attribution can be applied in the field of multi-channel retail, where users interact with different touchpoints through online and offline mediums (e.g., brick-and-mortar store visits, phone calls, etc.) in connection with the purchase of products. For example, the value of purchased products can be granularly attributed based at least in part on, or otherwise as a function of, user interactions with various touchpoints 440 and/or external influences affecting users as they pass through different steps of a particular conversion path. More specifically, in some embodiments, a visitor 422 (or visitors 422) may visit or otherwise interact with a touchpoint 440 via one or more devices (e.g., device A 428, device B 430, etc.) and/or mediums. In doing so, the visitor(s) 422 becomes a user 424 (or users 424) of the system 400. During the interaction with the touchpoint 440, the user 424 may make or perform various actions. At first, such actions may lead to the user 424 (or other visitors 422) becoming aware of a particular product 452. In doing so, the user 424 may learn about the product 452 and, in some cases, the product inventory 454. Thereafter, one or more actions of the user 424 (or other visitors 422) may lead the user 424 to subsequent stages of the conversion path (e.g., product interest, product/purchase decision, etc.) in connection with the purchase of the product 452.

In some embodiments, external influences (i.e., the influence data 462, the third-party data 464, etc.) may include information indicative of the product 452, the product inventory 454, groups of products 452, and/or the touchpoint 440 at which the product 452 and the product inventory 454 are presented to the user 424 (or other visitors 422). Such external influences may be provided to, or obtained by, the user 422 via one or more external data sources 460. In some embodiments, the effectiveness of the influence data 462 (or data or influences from any of the external data sources 460) may be evaluated in a variety of different ways. For example, a value or an amount of credit can be assigned to the influence data 462 based on when user actions and influences occur during the conversion path.

It should be appreciated that the exact products 452 with which the user 424 interacts via the touchpoint 440, the user's 424 opinion regarding these products 452, and how external influences (i.e., the influence data 462, the third-party data 464, etc.) moves the user 424 through the various stages of a conversion path are of great importance for decision makers, category managers, brand managers, and the like. This information advantageously helps such people understand the product categories (or brands) that have high efficiency in retail. As such, it will be appreciated that the technologies disclosed herein advantageously facilitate the influence-based evaluation and connection of the efforts taken to promote products, brands, and/or product groups with the results of such efforts (e.g., conversion of products) as the user 424 (or other visitors 422) pass through the various stages of the conversion path. Such technologies can be utilized to attribute value or credit in connection with any type of entity and/or any type of external influence.

As discussed, the system 400 is configured to granularly attribute value to different stages of a conversion path in connection with a product 452 and a user 424. To do so, in some embodiments, the system 400 may include an attribution server 402 (or other suitable component or device). As illustratively shown in FIG. 1, the attribution server 402 may include data collection processing logic 444, data segmentation processing logic 448, attribution processing logic 404, and data analysis processing logic 480. It should be appreciated that the data collection processing logic 444, data segmentation processing logic 448, attribution processing logic 404, and/or data analysis processing logic 480 may be embodied as hardware logic, software logic, or any combination thereof. In an example embodiment, the data collection processing logic 444 may be configured to collect customer information 420 associated with visitors 422 and/or a user 424. The customer information 420 collected and/or obtained by the data collection processing logic 444 may also include data indicative of the visitor's 422 and/or the user's 424 interaction with the touchpoint 440, data indicative of offline interactions 426 (e.g., offline purchases, etc.), and/or data indicative of external influences (e.g., the influence data 462, the third-party data 464, etc.). It should be appreciated that any other type of data from any other data source may be collected by the data collection processing logic 444 depending on the decision makers' needs and interests. For example, information about prices of the product 452 from different sources or information from different data management platforms may be gathered into the third-party data 464 and then retrieved by and/or sent to the data collection processing logic 444. In some embodiments, the data collection processing logic 444 may be configured to format or otherwise organize collected data into a standard or universal format (e.g., a reference data format type).

After collecting and, in some embodiments, formatting or reformatting the data, the data collection processing logic 444 transmits or otherwise provides the data to the data segmentation processing logic 448 (e.g., hardware logic, processing logic, instructions, etc.) of the attribution server 402. The data segmentation processing logic 448 is configured to analyze the received data and build connections between the user 424 (or users) of the touchpoint 440 and their interactions with the product 452 and information associated with the product 452 available via the touchpoint 440. In some embodiments, the data segmentation processing logic 448 is also configured to connect external influences that stimulated the user 424 to come to the touchpoint 440. For example, external influences such as an organic search, an advertisement banner, and/or an email message that influenced the user 424 to interact with the touchpoint 440 may be connected to the user's 424 interactions with the product 452 via the touchpoint 440.

It should be appreciated the data segmentation processing logic 448 can also be configured to make any other type of connection between the user 424 (or users) of the touchpoint 440 and their interactions with the product 452 and information associated with the product 452 available via the touchpoint 440. For example, the data segmentation processing logic 448 may connect information about the user 424 that came from an advertisement campaign (e.g., an advertising campaign targeted to the purchase of a frying pan) with the user's 424 interactions with the touchpoint 440. In another example, the data segmentation processing logic 448 may be configured to connect one or more users 424 that visited a brick-and-mortar store or received a call from a call center to the users' 424 interactions. In some examples, the data segmentation processing logic 448 may also be configured to connect information that a particular user 424 visited a product card page (e.g., a product description page) for a product 452 of one brand (e.g., a frying pan of Brand ‘X’) and then added a different product 452 of a different brand (e.g., a refrigerator of Brand ‘Y’) into an electronic shopping cart. The data segmentation processing logic 448 may also be configured to connect information about a user 424 that interacted with the touchpoint 440 as a result of a friend's recommendation for a specific product 452. In other examples, the data segmentation processing logic 448 may also be configured to connect information about a user 424 to various forms of product placement that prompted or influenced the user 424 to interact with the touchpoint 440 (e.g., the viewing by the user 424 of a blogger video including a specific product 452 mentioning).

After segmentation and/or connection by the data segmentation processing logic 448, the segmented data is divided between efforts 470—visitor interactions that did not lead to product purchases—and other visitor interactions. As shown in the illustrative embodiment, the other interactions are passed or otherwise provided to a funnel builder logic 406, which may form part of the attribution processing logic 404. The funnel builder logic 406 may be configured to enable customizable rules to be defined that associate or assign specific visitor interactions at the touchpoint 440 with one or more specific stages of a conversion path. In some embodiments, the funnel builder logic 406 may include various sales funnel stages (e.g., conversion path stages) such as, for example, awareness, interest, decision, action, and/or any other set of actions of interest for the particular touchpoint 440. For example, in embodiments in which the touchpoint 440 is a website, one or more stages of a conversion path may be defined that applies criteria for web pages viewed by the visitors 422 and/or actions performed by the visitors 422.

The custom rules defined by the funnel builder logic 406 may be passed to the user actions processing logic 408, which may be configured to query various data sources to determine all of the visitors' actions/interactions associated with the conversion path stages and the user's 424 position regarding different products 452 available at the touchpoint 440 with which the user 424 interacted. For example, actions such as the viewing of a product page, adding a product to an electronic shopping cart, and/or the completion of a checkout form may be determined for each particular user 424 and product 452. After determining such information, it may be processed by the probability processing logic 410 and the purchases processing logic 412 of the attribution processing logic 404.

The probability processing logic 410 is configured to evaluate the complexity of a user's 424 passage through the conversion path from one specific stage (e.g., ‘awareness’ stage) to another stage (e.g., ‘purchase’ stage). The propensity of the user 424 to pass from one stage of the conversion path to another depends on an analysis of user's 424 actions via the touchpoint 440 and may be analyzed through various different analysis techniques such as, for example, logistic regression or machine learning. The purchases processing logic 412 is configured to collect or identify sequences of one or more actions that led to progression of the user 424 to the last step of the conversion path (e.g., ‘purchase’) for the purchased product 452.

In the embodiment illustratively shown in FIG. 1, the attribution processing logic 404 may be configured to assign a portion or a share of credit (e.g., a value) to each action that stimulated one or more users 424 to pass to the next stage of the conversion path. In some embodiments, the portions or shares of credit assigned may be calculated based at least in part on probabilities. It should be appreciated that, in some embodiments, the attribution processing logic 404 may be configured to assign credit or a value only to those actions determined to be valuable actions (i.e., those that stimulated one or more users 424 to pass to the next stage of the conversion path). In doing so, the attribution processing logic 404 prevents the overvaluation of actions and/or influences that don't stimulate the users 424 (or visitors 422) to pass through the stages of the conversion path. In some embodiments, the attribution processing logic 404 may also be configured to store each stimulating user action and corresponding attributed value (and various parameters) in a data store, such as the valuable actions data store 414. The actions and values stored in the valuable actions data store 414 may be in the format of a list, a table, a record in a database, or any other format suitable for storing data and relationships. It should be appreciated that, during value assignment, the attribution processing logic 404 takes into account that probabilities of users 424 passing through the conversion path may depend on one or more user characteristics (e.g., geographic region or user type) and assigns values to user segments accordingly. In doing so, the attribution processing logic 404 makes output results more accurate. Also, it enables users of the system 400 to analyze interactions from any data source (e.g., tracking systems for the online touchpoint 440, internal customer relationship management (CRM) systems, enterprise resource planning (ERP) systems, records from brick-and-mortar stores, call centers, etc.).

In the embodiment illustratively shown in FIG. 1, the attribution processing logic 404 of the attribution server 402 also includes data analysis logic 480. The data analysis logic 480 is configured to evaluate the product 452 and the product inventory 454 presented via the touchpoint 440 as well as the influence data 462 (or other external influence data) based at least in part on, or otherwise as a function of, the user's 424 (or visitor's/visitors” 422) interactions via the touchpoint 440. The data analysis logic 480 is also configured to enable decision makers to compare the evaluation with approaches they currently use. For example, the data analysis logic 480 may be configured to provide a decision maker with information relating to a particular influence if it is determined that the influence is overvalued or undervalued in relative and monetary metrics of measuring influences effectiveness. Additionally or alternately, data generated by the data analysis logic 480 may include information indicative of the efficiency of a product 452 and/or an evaluation of various influences associated with a user's 424 (or a visitor's/visitors' 422) interaction with one or more products 452 via the touchpoint 440. The information generated by the data analysis logic 480 may be in the form of a report 482, a presentation, a diagram, or in any other format suitable for enabling decision makers to evaluate the data. Additionally or alternatively, the information generated by the data analysis logic 480 may be in the form of external application data 484, which may be formatted for further use, processing, and/or storage by one or more computing devices or processing applications.

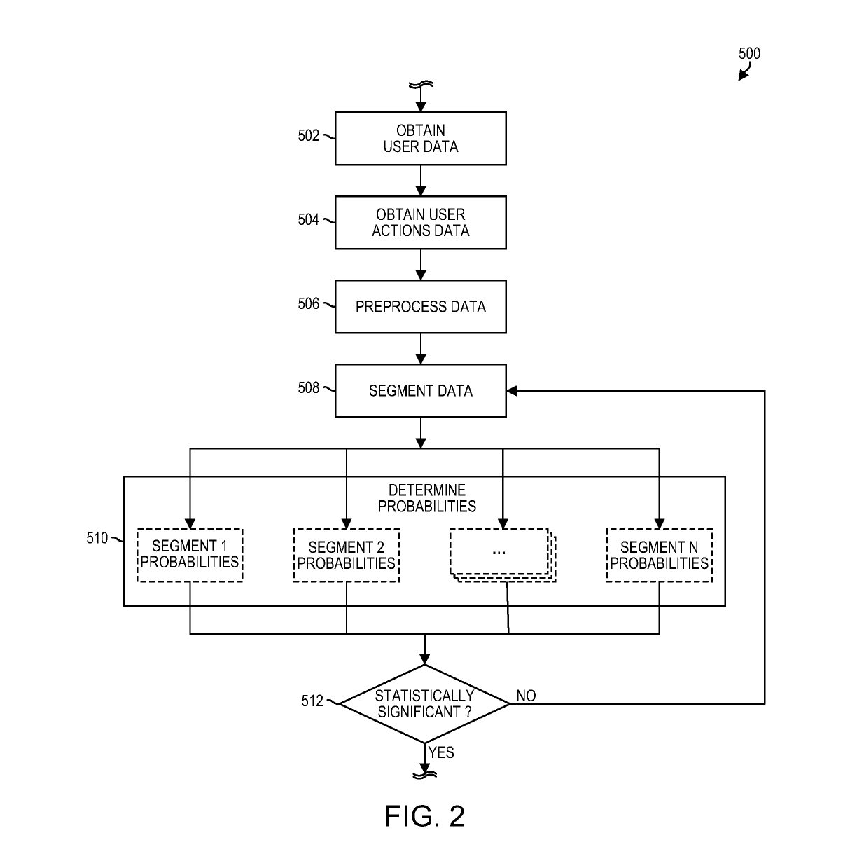

Referring now to FIG. 2, a method 500 that may be executed by the attribution server 402 for determining occurrence probabilities of conversion path stages begins with block 502. It should be appreciated that in some embodiments, the probability processing logic 410 of the attribution server 402 may execute the method 500. In block 502, the attribution server 402 obtains or otherwise retrieves user data. The user data may be data locally stored on one or more internal systems or devices (e.g., the device A 428, the device B 430, etc.) utilized by the user 424 (or other visitor(s) 422) to interact with the touchpoint 440. Subsequently, in block 504, the attribution server 402 obtains or otherwise retrieves user action data. The user action data may be the data generated by the user actions processing logic 408 and may be indicative of the actions/interactions of the users 424 and/or visitors 422 of the system 400 and the associated conversion path stages. In some embodiments, the attribution server 402 also obtains or retrieves the user interaction sequences identified by the purchases processing logic 412.

In block 506, the attribution server 402 preprocesses the user data and the user actions data. In some embodiments, the attribution server 402 also preprocesses the user interaction sequences together with the user data and the user actions data. To do so, the attribution server 402 may check various parameters and a maximum position of each user action/interaction within the conversion path. Actions/interactions that are not required for evaluation or were not a part of user 424 passing through the conversion path (e.g., funnel) are not taken into account during further evaluation. It should be appreciated that evaluation of first step actions/interactions may differ from later-step interactions because there are no prior actions/interactions associated therewith. As such, the attribution server may use a given or reference definition of valuable user engagement (e.g., actions/interactions with more than one action).

Next, in block 508, the attribution server 402 may segment or group the data by one or more user interaction parameters. It should be appreciated that any parameter may be chosen for segmenting the data. For example, in some embodiments, the one or more parameters may include a geographic region, a user type, a device category, or any other type of data. In some embodiments, each of the segmentation parameters is associated with a configurable priority value. For example, in embodiments in which the parameters include a geographic region, a user type, and a device category, the geographic region parameter may be assigned a priority value of ‘1’, the user type parameter may be assigned a priority value of ‘2’, and the device category parameter may be assigned a priority value of ‘3’. In some embodiments, it is preferable that the chosen parameters for segmentation have an impact on the probability of the user 424 passing through the funnel (i.e., conversion path). In block 510, the attribution server 402 of the attribution server 402 calculates a probability for each data segment.

In decision block 512, the attribution server 402 determines whether the probability for each of the data segments is statistically significant. To do so, the attribution server 402 may compare a confidence interval of each segment probability with a reference confidence level. If, in decision block 512, the attribution server 402 determines that each of the segment probabilities is statistically significant, the method 500 completes. If, however, the attribution server 402 determines instead that one or more segment probabilities are not statistically significant, the attribution server 402 omits the segmentation parameter having the lowest assigned priority and the method 500 loops back to blocks 508 and 510 for re-segmentation and probability calculation based on the remaining (e.g., non-omitted) segmentation parameter(s). By way of example, in response to determining that one or more of the segment probabilities is not statistically significant, the attribution server 402 may drop the device category segmentation parameter and re-segment or regroup the data based on the geographic region and user type parameters. Thereafter, the attribution server 402 may recalculate the probability for each of the geographic region data segment and user type data segments. Subsequently, the attribution server 402 may determine whether the probability for each of the geographic region and user type data segments are statistically significant. If not, the attribution server may repeat a similar process until either there is statistical significance or no more segmentation parameters remain. In the event that no more segment parameters remain, the attribution server 402 may calculate the average probability without segmentation.

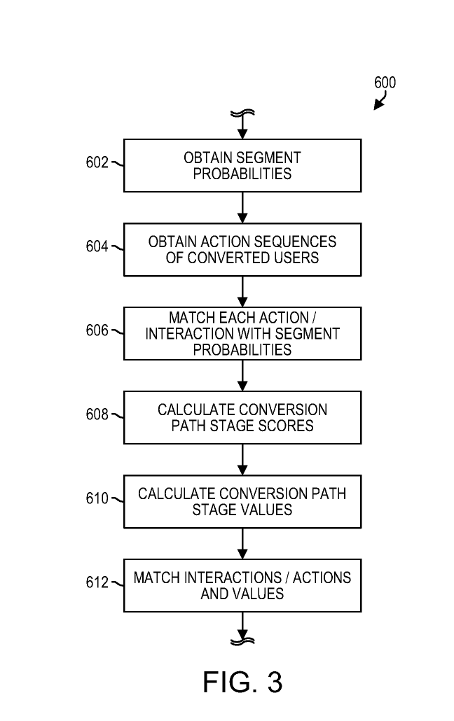

Referring now to FIG. 3, a method 600 that may be executed by the attribution server 402 for scoring and determining values for conversion path stages begins with block 602. It should be appreciated that in some embodiments, the attribution processing logic 404 of the attribution server 402 may execute the method 600. In block 602, the attribution server 402 obtains or otherwise retrieves the data segment probabilities. The data segment probabilities may be the segment probabilities generated by the probability processing logic 410 of the attribution server 402. Subsequently, in block 604, the attribution server 402 obtains or otherwise retrieves the user interaction/action sequences identified by the purchases processing logic 412. Next, in block 606, the attribution server 402 matches each interaction and/or action within each user interaction/action sequence that led to an item (i.e., product 452) purchase with the probabilities based at least in part on, or otherwise as a function of, the set of parameters used during segmentation and parameters of interactions.

In block 608, the attribution server 402 calculates or determines a score for each stage of the conversion path for each segment. The calculated score of a conversion path stage can have an inverse relationship to its probability. As such, the more difficult it is for the user 424 (or visitor 422) to pass through the conversion path (i.e., conversion funnel) to the stage/step, the greater score is for that stage/step. In some embodiments, the score for each stage/step of the conversion path can be defined according to the following formula:

Sᵢ=1−Pᵢ

where S is the score for a stage and P is the probability of the stage.

In block 610, the attribution server 402 calculates or determines a value for each stage (e.g., step) of the conversion path. The calculated value of a conversion path stage may be a share or a portion of the particular stage's score among the sum of all of the scores of all of the stages. In some embodiments, the value for a particular stage/step of the conversion path can be defined according to the following formula:

$${V}_{i} = \frac{{S}_{i}}{{\sum }_{n = 1}^{k} {S}_{n}}$$

where V is the value for a stage, S is the score for the stage, and k is the total number of stages in the conversion path.

In block 612, the attribution server 402 matches or assigns a value for each conversion path stage (e.g., step) in which the user 424 passed to the next stage. That is, if the user 424 passed through several stages within one interaction/action, it is assigned more value than interactions/actions that only passed through a single stage. If the stage is difficult for users 424 to pass through, interactions/actions performed within that stage are assigned more value than stages easier to pass through. Subsequently, the attribution server 402 stores each stimulating user action/interaction and corresponding attributed value (and various parameters) in a data store, such as the valuable actions data store 414. As discussed herein, the actions and values stored in the valuable actions data store 414 may be in the format of a list, a table, a record in a database, or any other format suitable for storing data and relationships. In embodiments in which attribution server 402 generates a list of valuable actions/interactions (i.e., the valuable actions data store 414), the list may include interactions/actions that stimulated users 424 (or visitors 422) of the touchpoint 440 (e.g., a medium through which a company offers products 452 to its customers) to pass through the different stages of the conversion path.

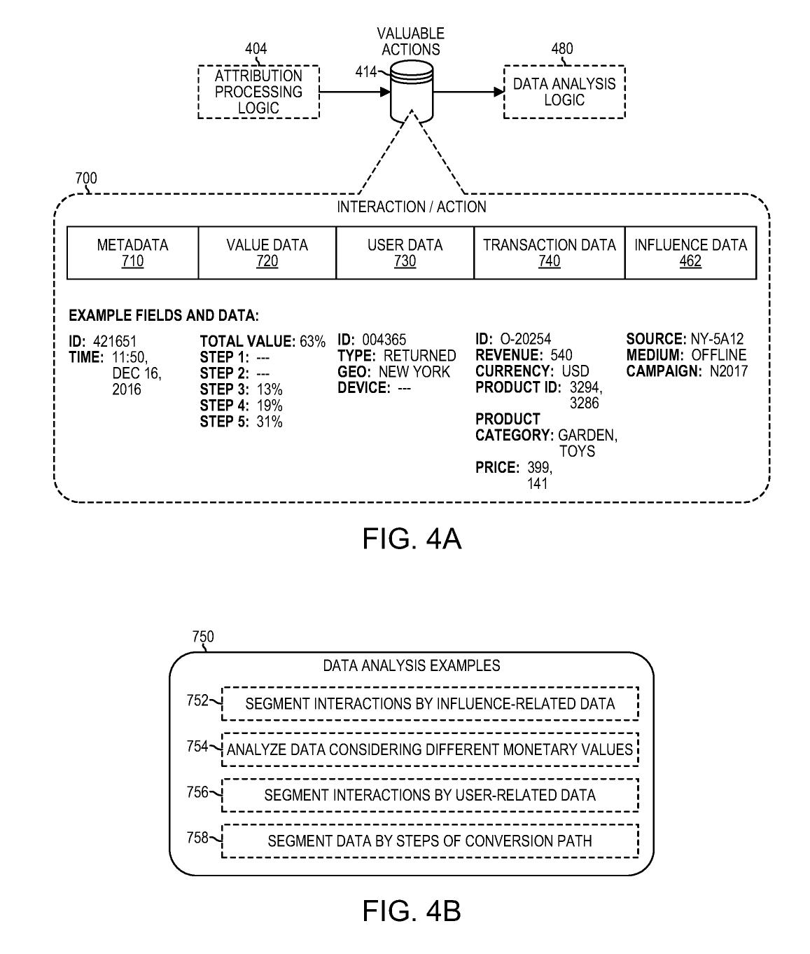

Referring now to FIG. 4A, an example of a user interaction/action data record 700 that may be generated by the attribution server 402 and stored in the valuable actions data store 414 is illustratively shown. The user interaction/action data record 700 may include interaction metadata 710, value data 720, user data 730, transaction data 740, and influence data 462. The interaction metadata 710 may include information such as a unique identifier for the interaction/action, a timestamp, and any other information associated with user interaction/action record 700. The value data 720 for the user interaction/action record 700 can be the value attributed to the user interaction/action by the attribution server 402 as discussed herein.

The user data 730 may include data or information identifying the user 424 making the action/interaction and/or a characteristic thereof. For example, in some embodiments, the user data 730 may include a unique user identifier and parameters used to segment the user's 424 actions/interactions (e.g., user type, user geographical region, user device category, etc.).

The transaction data 740 may include information describing or indicative of the transaction that resulted in the purchase of a product 452 (e.g., a conversion). For example, in some embodiments, the transaction data 740 may include a unique transaction identifier, unique identifiers of product(s) 452 purchased by the user 424, a category or categories of the product(s) 452 purchased by the user 424, price(s) of the product(s) 452 purchased by the user 424, and a date and time of the purchase transaction.

As discussed herein, the influence data 462 may be indicative of external influences and/or actions that stimulate the user 424 to pass through a conversion path. For example, in the case of multi-channel retail, the influence data 462 may include information indicative of the television or online advertising campaign(s) (e.g., influence source, influence medium, campaign identifier, etc.) that influenced the user 424 to pass through the conversion path.

As discussed, the attribution server 402 is configured to analyze the actions/interactions data and associated values. It should be appreciated that knowing value and key parameters of each interaction, enables users of the system 400 to make use of various actionable reports that can be generated by the attribution server 402. Data generated and analyzed by the attribution server 402 may be stored in a unified and open format, so it can be analyzed manually using different software for querying and visualizing data or tools powered by natural language processing technologies that generate all possible semantic queries based on analysis of data model.

Referring now to FIG. 4B, various exemplary data analysis processes 750 that can be performed by the attribution server 402 (e.g., via the data analysis logic 480) for generating user reports and/or output data from external applications or systems are illustratively depicted. For example, in some embodiments, the attribution server 402 can generate a report that segments interactions/actions by influence-related data (see block 752). Such report may show the value of different marketing channels in view of their contribution into all of the conversion path stages (e.g., steps). The report can be compared to conventional reports by decision makers to identify any influences that were previously under-valued or over-valued. Additionally, such a report can be used by decision makers when planning advertising (e.g., influence) spend amounts and the particular products 452 to sell.

Additionally or alternatively, in some embodiments, the attribution server 402 can generate a report that enables decision makers to analyze and compare the effectiveness of influences when considering different monetary values and measures (see block 754). For example, the attribution server 402 can generate a report that takes into account the orders completion rate and the gross margin.

In some embodiments, the attribution server 402 can also generate a report that segments user interactions/actions by user-related data (see block 756). Such a report may show the value of influences grouped by user parameters (e.g., user types such as new or returning users, user geographical regions, device types, etc.). This type of report may enable decision makers to gain insights regarding various influences. For example, decision makers may use the report to gain insights into which influences on average are underperforming but are good or favored by particular types of users or geographical regions.

Additionally or alternatively, in some embodiments, the attribution server 402 can generate a report that segments data by stages/steps of a conversion path (see block 758). Such a report may enable users of the system 400 to see the contribution of each influence on a particular conversion path stage/step. Additionally or alternatively, such a report may enable users of the system 400 to see the value of a particular influence split into conversion path stages. It should be appreciated that such information may drive insights about user behavior and enable decision makers (or other users of the system 400) to make more accurate, data informed decisions on influence optimization strategies.

It should be appreciated that the attribution server 402, device A 428, device B 430, touchpoint 440, and/or any other device of the system 400 can be embodied as any type of computing device capable of performing the functions described herein. As such, the attribution server 402, device A 428, device B 430, touchpoint 440, and/or any other device of the system 400 can include devices and structures commonly found in computing devices such as processors, memory devices, communication circuitry, and data storages, which are not shown in the figures for clarity of the description. It should be appreciated that, in some embodiments, the attribution server 402, device A 428, device B 430, touchpoint 440, and/or any other device of the system 400 can include one or more processors (e.g., CPUs, processing units, etc.) that execute instructions stored on a computer-readable or machine-readable medium to perform one or more of the functions described herein. Additionally or alternatively, the attribution server 402, device A 428, device B 430, touchpoint 440, and/or any other device of the system 400 can include hardware logic (e.g., logic circuits, etc.), software logic, or any combination thereof capable of performing one or more of the functions described herein. As such, in some embodiments, the attribution server 402, device A 428, device B 430, touchpoint 440, and/or any other device of the system 400 may be a special-purpose computing or processing device configured to attribute value to different stages of a conversion path and/or perform any of the other functions described herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for attributing a value of a conversion action to individual user actions of a multistage conversion path, the method comprising:
collecting, by an attribution server, customer information associated with a user of an online touchpoint, the customer information comprises interaction data indicative of one or more interactions with the online touchpoint by the user, wherein the online touchpoint presenting information corresponding to a product for purchase;
analyzing, by the attribution server, the customer information to associate the user with one or more of the interactions by the user with the information corresponding to the product for purchase presented by the online touchpoint;
assigning, by the attribution server, each of the one or more interactions by the user with one or more stages of a multistage conversion path;
grouping, by the attribution server, each of the one or more interactions by the user into segments according to one or more user interaction parameters;
determining, by the attribution server and for each of the segments, a probability of the user moving forward through the multistage conversion path;
calculating, by the attribution server, a score for each of the one or more stages of the multistage conversion path based at least in part on the probability determined for at least one of the segments; and
calculating, by the attribution server, a value for each of the one or more user actions that moved the user forward through the multistage conversion path based on the score of each stage and the sum of the scores of all of the stages.

2. The method of claim 1, wherein assigning each of the one or more interactions by the user with one or more stages of a multistage conversion path comprises assigning each of the one or more interactions by the user with one or more stages of a multistage conversion path based at least in part on one or more customizable rules.

3. The method of claim 1, wherein the multistage conversion path comprises at least one stage selected from a group consisting of a product awareness step, a product interest step, a product decision step, a user action step, and a purchase step.

4. The method of claim 1, wherein the one or more user interaction parameters comprise at least one user interaction parameter selected from a group consisting of a geographic region parameter, a user type parameter, and a user device category.

5. The method of claim 1, wherein each of the user interaction parameters is associated with a configurable priority value.

6. The method of claim 5, further comprising determining, by the attribution server, whether the probability of each of the segments is statistically significant.

7. The method of claim 6, wherein determining whether the probability of each of the segments is statistically significant comprises:
determining a confidence level for the determined probability for each of the segments; and
comparing the confidence level for the determined probability for each of the segments to a reference confidence level.

8. The method of claim 7, further comprising:
dropping, by the attribution server, the user interaction parameter of the one more user interaction parameters having the lowest configurable value;
regrouping, by the attribution server, each of the one or more interactions by the user into segments according to one or more remaining user interaction parameters;
re-determining, by the attribution server, a probability for each of the segments;
re-determining, by the attribution server, a confidence level for the determined probability for each of the segments; and
re-comparing, by the attribution server, the confidence level for the determined probability for each of the segments to a reference confidence level.

9. The method of claim 1, further comprising:
analyzing, by the attribution server, the value calculated for each of the one or more user actions that moved the user forward through the multistage conversion path; and
generating, by the attribution server, a report as a function of the analysis.

10. The method of claim 1, wherein the customer information comprises interaction data indicative of one or more interactions with the online touchpoint by the user via a remote computing device.

11. The method of claim 1, further comprising collecting, by the attribution server, external influence data presented to the user that stimulated the user to interact with the online touchpoint.

12. The method of claim 11, wherein the external influence data comprises external influence data selected from a group consisting of electronic search results, an online advertisement banner, and an electronic mail message including an advertisement.

13. A system for attributing a value of a conversion action to individual user actions of a multistage conversion path, the system comprising:
an attribution server comprising a processor executing instructions stored in memory, wherein the instructions cause the processor to:
collect customer information associated with a user of an online touchpoint, the customer information comprises (i) interaction data indicative of one or more interactions with the online touchpoint by the user and (ii) interaction data indicative of one or more offline interactions by the user, wherein the online touchpoint presents information that corresponds to a product for purchase;
analyze the customer information to associate the user with one or more of the interactions by the user with the information that corresponds to the product for purchase presented by the online touchpoint;
assign each of the one or more interactions by the user with one or more stages of a multistage conversion path;
group each of the one or more interactions by the user into segments according to one or more user interaction parameters;
determine, for each of the segments, a probability of the user moving forward through the multistage conversion path;
calculate a score for each of the one or more stages of the multistage conversion path based at least in part on the probability determined for at least one of the segments; and
calculate a value for each of the one or more user actions that moved the user forward through the multistage conversion path based on the score of each stage and the sum of the scores of all of the stages.

14. The system of claim 13, wherein to assign each of the one or more interactions by the user with one or more stages of a multistage conversion path comprises to assign each of the one or more interactions by the user with one or more stages of a multistage conversion path based at least in part on one or more customizable rules.

15. The system of claim 13, wherein each of the user interaction parameters is associated with a configurable priority value.

16. The system of claim 15, wherein the instructions of the attribution server further cause the processor to determine whether the probability of each of the segments is statistically significant.

17. The system of claim 16, wherein to determine whether the probability of each of the segments is statistically significant comprises to:
determine a confidence level for the determined probability for each of the segments; and
compare the confidence level for the determined probability for each of the segments to a reference confidence level.

18. The system of claim 17, wherein the instructions of the attribution server further cause the processor to:
drop the user interaction parameter of the one more user interaction parameters having the lowest configurable value;
regroup each of the one or more interactions by the user into segments according to one or more remaining user interaction parameters;
re-determine a probability for each of the segments;
re-determine a confidence level for the determined probability for each of the segments; and
re-compare the confidence level for the determined probability for each of the segments to a reference confidence level.

19. The system of claim 13, wherein the instructions of the attribution server further cause the processor to:
analyze the value calculated for each of the one or more user actions that moved the user forward through the multistage conversion path; and
generate by the attribution server, a report as a function of the analysis.

20. The system of claim 13, wherein the customer information comprises interaction data indicative of one or more interactions with the online touchpoint by the user via a remote computing device.
